(19) United States
(12) Patent Application Publication
(10) Pub. No.: US 2025/0283581 A1
(43) Pub. Date: Sep. 11, 2025

(54) COMPOSITE HIGH-PRESSURE VESSEL AND METHOD OF ITS FABRICATION

(71) Applicant: TECHPLAST SPÓLKA Z OGRANICZONA ODPOWIEDZIALNOSCIA, Andrychow (PL)

(72) Inventor: Piotr SAFERNA, Zagorze (PL)

(21) Appl. No.: 19/074,379

(22) Filed: Mar. 8, 2025

(30) Foreign Application Priority Data
Mar. 8, 2024 (PL) 447956

(51) Int. Cl. F17C 13/02; F17C 1/02

(52) U.S. Cl. CPC F17C 13/02; F17C 1/02; F17C 2203/011; F17C 2203/0607; F17C 2209/2127; F17C 2209/2154; F17C 2223/035; F17C 2250/0486

(57) ABSTRACT

A composite high-pressure vessel comprises a casing (1) made by blow molding a preform made of a thermoplastic material, a connection stub (3), a bottom dome (4) and a composite reinforcing coating made of a supporting braid (2) that consists of a bundle of filaments (5) embedded in resin, preferably containing nano-additives. At least one optical fiber (6) is embedded in at least one layer of the supporting braid (2), and its ends are led outside the composite reinforcing coating. The optical fiber (6) is led in a polar braid between the connection stub (3) and the bottom dome (4), at an angle of inclination to the vessel axis of 0°-30°. The optical fiber (6) may be additionally led in a hoop braid, with an angle a of inclination to the vessel axis of 45°-90°.

### CROSS-REFERENCE TO RELATED APPLICATIONS

The present patent application is filed under 35 U.S.C. 111(a), claiming priority from Polish patent application P. 447956, filed on Mar. 8, 2024, which content is incorporated herewith by reference for all purposes.

### FIELD OF THE INVENTION

The subject of the invention is a composite high-pressure vessel for storing liquids and/or gas under increased pressure and a method for its production.

### BACKGROUND

Polish patent PL228200B1 (also: WO2010059068A2, EP2531769A2) discloses a cylindrical high-pressure vessel containing a casing made by blow-molding a preform of thermoplastic PET, a connection stub, a bottom washer (bottom dome) and external reinforcement. The connection stub is provided with at least one groove for connection to the preform, with at least one sealing ring placed therein, as well as a groove for an O-ring seal. The connection stub also has a top cap and an annular protrusion around the opening of the connection stub. The casing made of the blown preform and the connection stub between the top cap and the annular projection are wrapped with at least one reinforcing layer, which consists of a resin-coated and thermally hardened layer of filaments applied on the entire surface of the tank in the cross-polar pattern, and additionally in a part of the tank having constant diameter (i.e. a cylindrical part) using the helical pattern. The angle of inclination of the filament applied in the cross-polar pattern, measured in relation to the axis of the tank, ranges from 49° to 59°. The filaments of the reinforcing layer are carbon, glass, aramid, basalt or ceramide fibers.

Another Polish patent PL226196B1 (also, among others: WO2015108429A1, EP3094914B1, U.S. Pat. No. 10,487,981B2) presents a method of manufacturing a composite high-pressure vessel, including production of a casing by blowing a preform made of thermoplastic material to the desired size using any suitable technique, then connecting the casing with a connection stub and strengthening the external surface of the tank by creating a composite layer. The preform equipped with a collar is previously subjected to a controlled crystallization process and then an annular groove is made in the preform's collar. Then the preform is blown to the desired size and connected to the connection stub equipped with a stop collar. An O-ring seal is placed in the sealing groove of the connection stub, and a snap ring is placed in the groove of the retaining ring, and then the connection stub is clamped onto the casing ring. Then, the interior of the created tank is filled with gas to obtain a constant value of pressure inside the tank and a composite layer is made by making a supporting braid from bundles of reinforcing filaments, using three winding methods: cross, polar and hoop, after which the whole device is thermally hardened. Curable resins, preferably epoxy, and filaments, preferably a bundle of carbon and aramid fibers, are used to make the composite layer. When making the supporting braid using the cross-polar pattern, the filament bundles are wound each time during the passages of the winding head between the poles of the tank and the passages around the connection stub while maintaining a constant angle of inclination of the rotation axis, preferably 53°-55°.

European patent application EP3795340A1 discloses a method of producing a high-pressure tank having a casing reinforced with an external composite reinforcing layer, consisting of the following steps: A) the outer surface of the tank body is covered with a thin anti-adhesive layer to prevent the reinforcing layer from sticking to the casing; B) an impregnating mixture of the resin composition and the nanoadditive is prepared in a mixing device at a pressure lower than normal pressure; C) the impregnating mixture is poured into the resin tray of the winding machine; D) at least one spool of carbon fiber bundles is mounted on the winding machine, each carbon fiber bundle containing at least 4 thousand, preferably 24 to 36 thousand carbon fibers; E) a curing agent is added to the impregnating mixture in a proportion of 29-30 wt. % of the impregnating mixture; F) the carbon fiber bundles are impregnated in a resin bath using a resin tray so that the impregnated carbon fiber bundle contains at least 65 wt. % of carbon fibers and at most 35 wt. % of the composition of the impregnating mixture and curing agent; G) the carbon fiber bundles are wound onto the casing by wrapping the impregnated carbon fiber bundles in at least 6 different winding patterns; H) the resulting composite reinforcing layer is thermally cured.

The same patent application also discloses a high-pressure vessel consisting of a casing and an outer composite reinforcing layer made of carbon fiber bundles wound around the outer surface of the casing and fastened with a hardened impregnating mixture composed of a resin composition and a nano-additive. The resin composition contains at least 75 wt. %, preferably 75-95 wt. % of bis-[4-(2,3-epoxypropoxy) phenyl] propane and up to 25 wt. %, preferably 5-25 wt. % of 1,4-bis (2,3-epoxypropoxy) butane. The nanoadditive consists of at least 80 wt. % of graphene nanotubes (GNT), at most 15 wt. % of iron (Fe) nanoparticles and at most 5 wt. % of other allotropic forms of carbon, such as graphene flakes or fullerenes. GNTs are single-walled graphene nanotubes (SWGNT) with a diameter of 1-2 nm and a length of at most 20 micrometers, and a length-to-diameter ratio of at least 100. The impregnating mixture contains 99.9-99.99 wt. % of resin composition and 0.01-0.1 wt. % of nanoadditive.

So far, monitoring the condition of the pressure vessels mainly involved the use of external sensors and measurement systems that may not have been fully integrated with the tank material. Existing systems were often focused on detection of leak or pressure drop, but were not always able to accurately monitor internal stresses and temperatures under dynamically changing operating conditions. Without careful monitoring, there is an increased risk of not detecting early signs of damage, which may lead to structural failures.

A high-pressure fuel tank for a vehicle powered with gas fuel and a method of producing the tank are known from the Korean patent KR100658116B1. The invention makes it possible to detect the deformation of the fuel tank without disconnecting it from the vehicle, by installing a deformation sensor in the tank. The fuel tank includes a cylindrical casing for storing gaseous fuel under high pressure; carbon fiber wrapped around the outer peripheral surface to increase the tank strength; a strain sensor wrapped around one side of the carbon fiber to detect the casing deformation; and a reinforcing coating wrapped around a portion of the outer peripheral surface of the strain sensor to protect it from bending. The strain sensor consists of an FBG sensor (Fiber Bragg Grating), which changes the wavelength of light reflected by the grid upon deformation and thus measures the degree of deformation of the cladding, and an optical fiber connected to both ends of the FBG sensor to transmit light to/from the FBG sensor.

The above mentioned invention has been further developed in Korean patent application KR20160086459A to enable mass production of high-pressure gas tanks with intelligent real-time monitoring of the stress signal in the tank by integrating it with the pressure and temperature signals inside the high-pressure gas tank. The inventors of the solution pointed out that in order to check the degree of loss of strength of the pressure tank, it is necessary to remove the tank from the vehicle and report it to a specialized inspection station, and then perform an external inspection of the tank for external damage. The problem is that it is difficult to identify potential internal and external structural changes in advance. The invention in question includes, among others: a fiber optic sensor that creates a specific pattern on the surface of the fiber so that only specific wavelengths of the input wavelengths are reflected, i.e. being a Bragg grating. The authors noted that the FBG sensors have a relatively low price and are suitable for high-pressure gas tanks. For this purpose, a winder was developed that installs the fiber optic sensor on the reinforcing fiber braid and has a fiber optic sensor fixing and release function to automatically insert the fiber optic sensor while winding in the same direction as the reinforcing filament.

A similar solution is known from the Japanese patent document JP2001248731A, according to which the pressure container is made of reinforced plastic with a woven fiber braid in which a sensing material, at least containing an optical fiber, is embedded. The optical fiber is woven together with the braid, creating successive rows of pseudo-warp. The condition of a pressurized container can be checked by measuring a difference in the amount of light radiated to one end of the appropriate optical fibers and the amount of light reaching the other end, or by measuring the characteristic change in light incident on one end and emitted from the other end of the optical fiber.

High-pressure containers with installed fiber optic sensors are also known from patent documents CN218494746U, CN113686924A and CN209370839U.

In most of the known solutions mentioned above, the optical fiber is guided circumferentially (i.e. wound in circular loops around the cylindrical part of the tank body), which enables measurement of radial deformation, but does not enable measurement of axial deformation of the tank. Only in the solutions described in JP2001248731A and CN209370839U the optical fiber is led along the tank, i.e. in the axial direction. However, the methods of wrapping the optical fiber proposed in these documents consist in almost point-like (i.e. with a very small radius of curvature, comparable to the thickness of the optical fiber) bending the optical fiber by 360 degrees in order to turn it back and multiply the number of passes along the length of the tank. During measurement, this results in very high signal power losses and measurement errors due to the introduction of high stresses into the optical fiber itself at its bends. Large measurement errors eliminate the proposed methods of guiding the optical fiber from practical use, because the measured axial deformations are so small that the measurement must be performed with high accuracy and with low signal losses. This means that not only accidental (random) errors affecting the measurement data, but above all, systematic measurement errors must be minimized.

### SUMMARY

The authors of the claimed invention faced a technical problem of how to lead an optical fiber along the surface of the tank casing that would enable measurement of the axial deformation of the casing whilst it would not cause significant signal loss and would not be burdened with large measurement errors resulting from the introduction of stresses into the optical fiber itself already in the phase of the tank production.

The invention solves the technical problem identified above in that the optical fiber is led essentially along the generatrice of the casing, but the loci of turning back the optical fiber are moved to rounded areas at the ends of the tank, i.e. adjacent to the connection stub at the one end and the bottom dome at the other end. Thanks to this, the bending radius of the optical fiber is comparable to the radius of curvature of the tank wall and is therefore very large compared to the diameter of the optical fiber. In this way, the next fiber optic measurement section is moved to the opposite side of the tank, after which the fiber returns to the previous side of the tank and winding continues, with a relative angular shift of adjacent windings.

The composite high-pressure vessel, according to the invention, includes a casing made by blowing from a preform made of thermoplastic material, a connection stub, a bottom dome, and a composite reinforcing coating consisting of a supporting braid made of a bundle of filaments embedded in resin, wherein at least one optical fiber is embedded in at least one layer of the supporting braid, and its ends are led outside the composite reinforcing coating. At least one optical fiber is led in a polar braid, with an angle of inclination a to the tank axis of 0°-30°.

In a variant of the invention, the optical fiber is additionally led in a hoop braid, with an angle b of inclination to the tank axis of 45°-90°. In this variant, it may be the same optical fiber that is led in a polar braid, or a separate optical fiber. In the first case, the measurement using one optical fiber covers both radial and axial deformations of the tank. In the second case, a polarly guided optical fiber allows for axial strain measurements, while the second optical fiber applied in the hoop pattern is used to measure radial strains.

It should be emphasized that the causes of both types of deformations may be different. For example, radial deformations may depend on the current resistance of the tank to the value of the fluid pressure in the tank and to changes, including the rate (dynamics) of changes in this pressure. Axial deformations may indicate a decrease in the cohesion of the tank walls or a progressive detachment of the connection stub or the bottom dome. Moreover, radial deformations do not necessarily occur together with axial deformations and vice versa. By separating the measurements into axial and radial, the invention enables early identification of various types of tank deformations and their causes, before progressive damage would cause a serious failure, and in particular a very dangerous leakage of the tank.

Measurements using optical fiber can be carried out in any tank configuration (installed vs. dismounted, filled vs. empty), which of course requires connecting the ends of each optical fiber to an appropriate measuring device.

In the preferred variant, the optical fiber is embedded in the outer layer of the supporting braid and thus the measurements reflect the condition of the entire vessel, i.e. the casing with the supporting braid. In another variant, the optical fiber can be embedded only in the inner layer of the supporting braid, and then the measurements reflect the condition of the casing itself. One or more optical fibers may also be embedded in many or, in extreme cases, in all layers of the supporting braid. In particular, when one optical fiber is led in hoop winding and the other polarly, they should be embedded in different layers of the supporting braid.

Depending on the assumed measurement program, a single-mode or multi-mode optical fiber can be selected for braiding. It is also possible to use different types of optical fibers in one supporting braid. The choice of the fiber type may depend on the planned wavelengths of light used for measurements. At a given cut-off wavelength, the same optical fiber will be single-mode for longer waves and multi-mode for shorter waves.

In another variant, the optical fiber is equipped with at least one Bragg grating (FBG), preferably with reflectance maxima at different wavelengths. With one Bragg grating, a measurement program based on a monochromatic light beam can be used. However, if an optical fiber with multiple Bragg gratings is used, they should have mutually shifted (in terms of wavelength) reflection maxima, and then the measurement program should use a light beam containing all the wavelengths needed for measurements, for example a white light beam.

It is recommended that the optical fiber be led parallel to the filaments bundle of the supporting braid, because the filaments of this braid then play a protective role for the optical fiber.

In a preferred variant, the filament bundle in the supporting braid is a bundle of carbon or aramid or carbon-aramid fibers, preferably consisting of two outer carbon fibers and a central aramid fiber. The carbon fiber bundle in the supporting braid contains 4-36 thousand, preferably 24-36 thousand carbon fibers with a diameter of 5-7 mm.

The supporting braid preferably contains 65 wt. % filament bundles and 35 wt. % resin. The resin in the composite reinforcing coating contains a nano-additive containing carbon nanotubes, preferably at least 80 wt. % graphene nanotubes (GNT), at most 15 wt. % iron nanoparticles and at most 5 wt. % other allotropic forms of carbon such as graphene flakes or fullerenes. In the recommended embodiment of the invention, graphene nanotubes are single-layer (SWGNT) and have a diameter of 1-2 nm, a length not exceeding 20 mm and a length-to-diameter ratio of at least 100.

The method of manufacturing a composite high-pressure vessel includes producing a casing by blowing a preform made of thermoplastic material to the desired size, connecting the casing with a connection stub and a bottom dome, and strengthening the outer surface of the vessel by creating a composite reinforcing coating made of a supporting braid consisting of a bundle of filaments embedded in resin, wherein at least one optical fiber is embedded in at least one layer of the supporting braid and its ends are led outside the composite reinforcing coating. At least one optical fiber is led in a polar braid, with an angle of inclination a to the tank axis of 0°-30°.

In a preferred variant of the method, the optical fiber is additionally led in a hoopl braid, with an angle b of inclination to the tank axis of 45°-90°.

The optical fiber is embedded in the outer layer of the supporting braid, or in the inner layer of the supporting braid, or in all layers of the supporting braid.

In order to implement the desired variant of the composite vessel manufacturing method, a single-mode or multi-mode optical fiber is selected, or is equipped with at least one Bragg grating, preferably many Bragg gratings with reflectance maxima falling at different wavelengths.

According to the proposed method, the optical fiber is led parallel to the filament bundle of the supporting braid, preferably at an angle of inclination to the tank axis of 86°-89°. Preferably, a bundle of carbon or aramid, or carbon-aramid fibers consisting of two outer carbon fibers and a middle aramid fiber is used as a fiber bundle in the supporting braid. If a bundle of carbon fibers is used to make the supporting braid, in the recommended variant it contains 4-36 thousand, preferably 24-36 thousand carbon fibers with a diameter of 5-7 mm.

According to the preferred variant of the method of making the pressure vessel, the supporting braid contains 65 wt. % filament bundles and 35 wt. % resin. The resin in the composite reinforcing coating contains a nano-additive containing carbon nanotubes, preferably at least 80 wt. % of graphene nanotubes (GNT), at most 15 wt. % iron nanoparticles and at most 5 wt. % other allotropic forms of carbon such as graphene flakes or fullerenes. Graphene nanotubes are single-layer (SWGNT) and have a diameter of 1-2 nm, a length not exceeding 20 mm and a length-to-diameter ratio of at least 100.

In a variant of the claimed method, the production of a composite reinforcing coating made of a supporting braid consisting of a filament bundle embedded in resin, with at least one optical fiber built-in, includes the following steps:
a) at least one spool of the bundle of filaments, preferably carbon fibers, and at least one spool of the optical fiber are mounted on the winding machine;
b) the outer surface of the casing is covered with a thin anti-adhesive layer to prevent the composite reinforcing coating from bonding to the casing;
c) the resin, preferably with the nano-additive, is prepared in a mixing device at a pressure lower than normal;
d) the resin, preferably with the nano-additive, is poured into a resin tray in the winding machine;
e) a curing agent is added in a ratio of 29-30 wt. % of the resulting impregnating mixture to the resin, preferably with the nano-additive, poured into the resin tray in the winding machine;
f) at least one bundle of filaments, preferably carbon fibers, is impregnated in a resin bath using the resin tray, maintaining in the impregnated bundle a proportion of at least 65 wt. % of bundle of filaments, preferably carbon fibers, and at most 35 wt. % of the impregnating mixture consisting of a resin, preferably with the nano-additive, and the curing agent;
g) at least one impregnated bundle of filaments, preferably carbon fibers, is wound, preferably in a hoop, polar or cross-weave braid, onto the casing by wrapping in at least six different winding patterns, wherein the at least one impregnated bundle of filaments, preferably carbon fibers, is wound in the selected at least one layer together with at least one optical fiber;
h) the composite reinforcing layer is thermally cured.

By making the supporting braid in a cross-pole manner, bundles of filaments, preferably carbon fibers, are wound each time during the passages of the winding head between the poles of the tank casing and during the passages of the winding head around the connection stub while maintaining the angle of inclination of the rotation axis, preferably 53°-55°, preferably causing the tank to vibrate slightly.

The winding of filament bundles, preferably carbon fibers, is carried out at a constant internal pressure in the tank casing, ranging from 2.0 to 2.8 bar, with the value of the internal pressure in the tank casing being inversely proportional to its size, and the tension of the filament bundles, preferably carbon, in the winding machine is at least 10 N.

When making the supporting braid, 10 to 12 wraps of filament bundles, preferably carbon fibers, are wound successively, including preferably four braids using the polar pattern, preferably three braids using the cross pattern, preferably three braids using the hoop pattern, and preferably one braid using the polar pattern, wherein preferably in the last polar braid at least one optical fiber is wound together with a bundle of preferably carbon fibers.

The proposed solution involves integrating optical fibers with the composite material during the winding process, which allows for direct and continuous monitoring of the stress state and temperature of the tank. This integration increases the accuracy and sensitivity of measurements, enabling the detection of subtle changes in the material structure that may signal the initial stages of damage. This system is able to respond better to changing operating conditions, which is crucial in the case of tanks being subject to various types of loads and temperature changes. Through more accurate monitoring, the system can help to increase overall safety by preventing failures and structural damage to the tank. The proprietary solution combines the innovative use of fiber optic technology with advanced composite techniques, which represents an advancement in the field of pressure vessel monitoring.

The main advantages of the invention include:
ability to adapt winding techniques to different types of sensors and monitoring requirements;
increasing the flexibility of tank design in terms of specific user requirements;
inclusion of optical fibers for direct real-time monitoring of stress and temperature;
faster detection of even minor damage, enabling early intervention and reducing repair costs and downtime;
the ability to simultaneously monitor many parameters of the tank's technical condition in an invisible and non-invasive way;
significant improvement in the sensitivity and accuracy of measurements compared to traditional monitoring methods, thanks to the use of optical fibers;
ability to detect subtle changes in the structure of the tank, which was previously difficult or impossible;
direct integration of the monitoring system with the tank structure, contributing to extending the life of the tank and increasing the level of safety;
expanding the area of application of composite pressure vessels in various industrial sectors;
enabling planning of tank maintenance and servicing based on the actual technical condition, rather than rigid schedules;
ability to proactively manage the condition of tanks, including more effective risk management.

### BRIEF DESCRIPTION OF THE SEVERAL VIEWS OF THE DRAWINGS

The composite high-pressure tank and the method of winding the supporting braid during the production of the tank are presented in examples of embodiment in the drawings, in which:

FIG. 1 shows a schematic axial section of a high-pressure tank, with a composite reinforcing coating applied to the casing with the spigot and bottom dome installed;

FIG. 2 shows a side view of a diagram of winding a filament bundle together with an optical fiber onto a polar braided tank casing;

FIG. 3 shows a side view of a diagram of winding a filament bundle with an additional optical fiber onto the tank casing in a hoop braid.

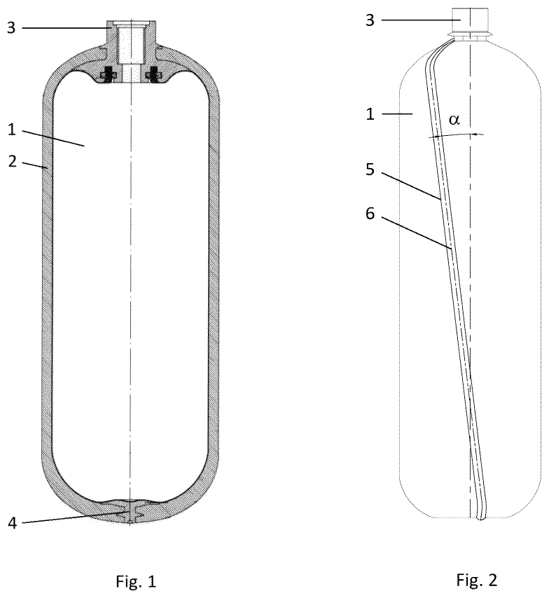

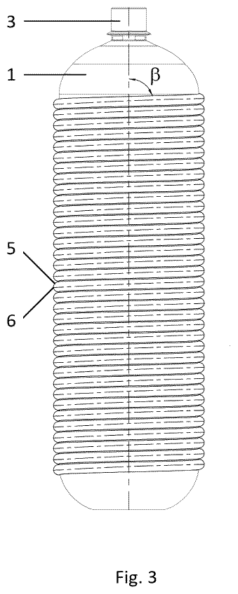

### DETAILED DESCRIPTION OF THE INVENTION

The composite high-pressure tank in the recommended embodiment includes a casing (1) made by blowing from a preform made of thermoplastic material, a connection stub (3), a bottom dome (4) and a composite reinforcing coating made of a supporting braid (2) consisting of a bundle of filaments (5) embedded in resin, with at least one optical fiber (6) embedded in at least one layer of the supporting braid (2), wherein its ends are led outside the composite reinforcing coating. One optical fiber (6) is routed in an external polar braid, at an angle of inclination to the tank axis of approximately 15°.

In a variant of the invention, an additional, second optical fiber (6) is led in the layer with a hoop braid, at an angle b of inclination to the tank axis of approximately 80°. This layer is located under the outer layer with the optical fiber led polarly. Thus, in a preferred variant, one optical fiber (6) is embedded in the outer layer of the supporting braid (2) and the other-in the inner layer of the supporting braid (2) located below.

In one embodiment intended for Raman and Brillouin scattering measurements, the optical fiber (6) is a single-mode or multi-mode one. In another variant, for interferometric measurements, the optical fiber (6) is equipped with at least one Bragg grating, preferably with reflectance maxima at different wavelengths.

In the implemented example, the optical fiber (6) was run parallel to the filament bundle (5) of the supporting braid (2).

The bundle of filaments (5) in the supporting braid (2) is a carbon fiber bundle and contains 24-36 thousand carbon fibers with a diameter of 5-7 mm.

The supporting braid (2) contains 65 wt. % of filament bundles (5) and 35 wt. % resin. The resin in the composite reinforcing coating contains a nano-additive containing carbon nanotubes, preferably at least 80 wt. % of graphene nanotubes (GNT), at most 15 wt. % iron nanoparticles and at most 5 wt. % other allotropic forms of carbon such as graphene flakes or fullerenes.

Graphene nanotubes are single-walled (SWGNT) and have a diameter of 1-2 nm, a length not exceeding 20 mm and a length-to-diameter ratio of at least 100.

The method of manufacturing a composite high-pressure tank includes producing the casing (1) by blowing a preform made of thermoplastic material to the desired size, connecting the casing (1) with the connection stub (3) and the bottom dome (4), and strengthening the outer surface of the tank by forming a composite reinforcing coating made of a supporting braid (2) consisting of a filament bundle (5) embedded in resin, where at least one optical fiber (6) is embedded in at least one layer of the supporting braid (2), and its ends being led outside the composite reinforcing coating. At least one optical fiber (6) is led in a polar braid, with an angle of inclination a to the tank axis of 0°-30°, e.g. 15°.

The optical fiber (6) is additionally routed in the hoop braid, with an angle b of inclination to the tank axis of 45°-90°. Depending on the assumed braid density, this angle may be, for example, 60°, 70° or 80°.

The optical fiber (6) is embedded in the outer layer of the supporting braid (2), or in the inner layer of the supporting braid (2), or in all layers of the supporting braid (2).

In order to implement the recommended variant of the method of manufacturing the composite tank, the optical fiber (6) is selected as a single-mode or multi-mode fiber, or equipped with at least one Bragg grating, preferably many Bragg gratings with reflectance maxima falling at different wavelengths.

According to the proposed method, the optical fiber (6) is led parallel to the filament bundle (5) of the supporting braid (2), preferably at an angle of inclination to the tank axis of 86°-89°. A carbon fiber bundle containing 4-36 thousand, preferably 24-36 thousand carbon fibers with a diameter of 5-7 mm was used as a filament bundle (5) in the supporting braid (2).

According to the method of making the pressure vessel, the supporting braid (2) contains 65 wt. % of the filament bundles (5) and 35 wt. % of resin. The resin in the composite reinforcing coating contains a nano-additive containing carbon nanotubes, preferably at least 80 wt. % graphene nanotubes (GNT), at most 15 wt. % iron nanoparticles and at most 5 wt. % other allotropic forms of carbon such as graphene flakes or fullerenes. Graphene nanotubes are single-layer (SWGNT) and have a diameter of 1-2 nm, a length not exceeding 20 mm and a length-to-diameter ratio of at least 100.

In a variant of the claimed method, the production of the composite reinforcing coating made of a supporting braid (2) composed of a filament bundle (5) embedded in resin, with at least one optical fiber (6) built-in, includes the following steps:
a) at least one spool of the bundle of filaments (5), preferably carbon fibers, and at least one spool of the optical fiber (6) are mounted on the winding machine;
b) the outer surface of the casing (1) is covered with a thin anti-adhesive layer to prevent the composite reinforcing coating from bonding to the casing (1);
c) the resin, preferably with the nano-additive, is prepared in a mixing device at a pressure lower than normal;
d) the resin, preferably with the nano-additive, is poured into a resin tray in the winding machine;
e) a curing agent is added in a ratio of 29-30 wt. % of the resulting impregnating mixture to the resin, preferably with the nano-additive, poured into the resin tray in the winding machine;
f) at least one bundle of filaments (5), preferably carbon fibers, is impregnated in a resin bath using the resin tray, maintaining in the impregnated bundle a proportion of at least 65 wt. % of bundle of fibers (5), preferably carbon fibers, and at most 35 wt. % of the impregnating mixture consisting of a resin, preferably with the nano-additive, and the curing agent;
g) at least one impregnated bundle of filaments (5), preferably carbon fibers, is wound, preferably in a hoop, polar or cross-weave braid, onto the casing (1) by wrapping in at least six different winding patterns, wherein the at least one impregnated bundle of filaments (5), preferably carbon fibers, is wound in the selected at least one layer together with at least one optical fiber (6);
h) the composite reinforcing layer is thermally cured.

By making the supporting braid (2) in a cross-polar pattern, the bundles of filaments (5), preferably carbon fibers, are wound each time during the passages of the winding head between the poles of the casing (1) of the tank and during the passages of the winding head around the connection stub (3) while maintaining the angle of inclination of the rotation axis, preferably 53°-55°, preferably causing the tank to vibrate slightly.

The winding of bundles of filaments (5), preferably carbon fibers, is carried out at a constant internal pressure in the tank casing (1), ranging from 2.0 to 2.8 bar, while the value of the internal pressure in the tank casing (1) is inversely proportional to its size, and the tension of the bundle of filaments (5), preferably carbon fibers, in the winding machine is at least 10 N.

When making the supporting braid (2), 10 to 12 windings of filament bundles (5), preferably carbon fibers, are wound successively, including preferably four braids in the polar pattern, preferably three braids in the crosswise pattern, preferably three braids in the hoop pattern and preferably one braid in the polar pattern, wherein at least one optical fiber (6) is preferably wound together with a bundle of filaments (5), preferably carbon fibers, in the last polar braid.

To make the composite high-pressure vessel, an optical fiber from Yangtze Optical Fiber and Cable Joint Stock Ltd. Co., marked PH 9/125-14/250, was used. For this optical fiber, the cutoff wavelength is less than 1310 nm. For wavelengths longer than this value (infrared), the fiber is single-mode, while for shorter wavelengths (near infrared, visible light) the fiber is multimode. According to the fiber properties determined by the producer, for a bend radius of 10 mm, the induced signal power loss is less than 0.5 dB for a wavelength of 1550 nm and less than 1.5 dB for a wavelength of 1625 nm. This means that when bending on the surface of the invented vessel, the radius of curvature of which can be of the order of 100 mm, the signal power loss in the optical fiber induced by the bend is negligeable.

1. A composite high-pressure vessel comprising a casing (1) made by blow molding a preform made of a thermoplastic material, a connection stub (3), a bottom dome (4) and a composite reinforcing coating made of a supporting braid (2) that consists of a bundle of filaments (5) embedded in resin, wherein at least one optical fiber (6) is embedded in at least one layer of the supporting braid (2), and its ends are led outside the composite reinforcing coating, and wherein said at least one optical fiber (6) is led in a polar braid between the connection stub (3) and the bottom dome (4), at an angle a of inclination to the vessel axis of 0°-30°.

2. The composite vessel according to claim 1, characterized in that the optical fiber (6) is additionally led in a hoop braid, with an angle β of inclination to the vessel axis of 45°-90°.

3. The composite vessel according to claim 1, characterized in that the optical fiber (6) is embedded in the outermost layer or in the innermost layer, or in all layers of the supporting braid (2).

4. The composite vessel according to claim 1, characterized in that the optical fiber (6) is a single-mode or a multimode fiber depending on the used light wavelength.

5. The composite vessel according to claim 1, characterized in that the optical fiber (6) has at least one Bragg grating, preferably with maxima of reflection coefficient falling at different wavelengths.

6. The composite vessel according to claim 1, characterized in that the optical fiber (6) is led parallel to the bundle of filaments (5) of the supporting braid (2), and in that the supporting braid (2) contains 65 wt. % of bundle of filaments (5) and 35 wt. % of resin.

7. The composite vessel according to claim 1, characterized in that the bundle of filaments (5) in the supporting braid (2) is a bundle of carbon or aramid or carbon-aramid fibers, the latter preferably consisting of two outer carbon fibers and a middle aramid fiber.

8. The composite vessel according to claim 7, characterized in that the bundle of carbon fibers in the supporting braid (2) contains 4-36 thousand, preferably 24-36 thousand carbon fibers with a diameter of 5-7 mm.

9. The composite vessel according to claim 1, characterized in that the resin in the composite reinforcing coating contains a nano-additive containing carbon nanotubes, preferably at least 80 wt. % of graphene nanotubes, at most 15 wt. % of iron nanoparticles, and at most 5 wt. % of other allotropic forms of carbon such as graphene flakes or fullerenes.

10. The composite vessel according to claim 9, characterized in that the graphene nanotubes are single-layer and have a diameter of 1-2 nm, a length not exceeding 20 μm and a length-to-diameter ratio of at least 100.

11. A method for producing a composite high-pressure vessel, including manufacturing of a casing (1) by blow-molding a preform made of thermoplastic material to the desired size, connecting the casing (1) with a connection stub (3) and a bottom dome (4), and strengthening the outer surface of the vessel by forming a composite reinforcing coating made of a supporting braid (2) composed of a bundle of filaments (5) embedded in resin, wherein at least one optical fiber (6) is embedded in at least one layer of the supporting braid (2) and its ends are led outside the composite reinforcing coating, and wherein said at least one optical fiber (6) is led in a polar braid, with an angle a of inclination to the vessel axis of 0°-30°.

12. The method according to claim 11, characterized in that manufacturing of the composite reinforcing coating made of the supporting braid (2) composed of the bundle of filaments (5) embedded in resin, with at least one optical fiber (6) built-in, includes the following steps:
a) at least one spool of the bundle of filaments (5), preferably carbon fibers, and at least one spool of the optical fiber (6) are mounted on the winding machine;
b) the outer surface of the casing (1) is covered with a thin anti-adhesive layer to prevent the composite reinforcing coating from bonding to the casing (1);
c) the resin, preferably with the nano-additive, is prepared in a mixing device at a pressure lower than normal;
d) the resin, preferably with the nano-additive, is poured into a resin tray in the winding machine;
e) a curing agent is added in a ratio of 29-30 wt. % of the resulting impregnating mixture to the resin, preferably with the nano-additive, poured into the resin tray in the winding machine;
f) at least one bundle of filaments (5), preferably carbon fibers, is impregnated in a resin bath using the resin tray, maintaining in the impregnated bundle a proportion of at least 65 wt. % of bundle of filaments (5), preferably carbon fibers, and at most 35 wt. % of the impregnating mixture consisting of a resin, preferably with the nano-additive, and the curing agent;
g) at least one impregnated bundle of filaments (5), preferably carbon fibers, is wound, preferably in a hoop, polar or cross-weave braid, onto the casing (1) by wrapping in at least six different winding patterns, wherein the at least one impregnated bundle of filaments (5), preferably carbon fibers, is wound in the selected at least one layer together with at least one optical fiber (6);
h) the composite reinforcing layer is thermally cured.

13. The method according to claim 12, characterized in that when making the supporting braid (2) with a polar-cross weaving pattern, the bundles of filaments (5), preferably carbon fibers, are wound each time during the passages of the winding head between the poles of the casing (1) and during the passages of the winding head around the connection stub (3) while maintaining the angle of inclination to the rotation axis of the casing (1), preferably 53°-55°, and preferably causing the casing (1) to vibrate slightly.

14. The method according to claim 12, characterized in that winding of the bundles of filaments (5), preferably carbon fibers, is carried out at a constant internal pressure in the casing (1), ranging from 2.0 to 2.8 bar, wherein the value of the internal pressure in the casing (1) is inversely proportional to its size, and tension of the bundle of filaments (5), preferably carbon fibers, in the winding machine is of at least 10 N.

15. The method according to claim 12, characterized in that, when making the supporting braid (2), 10 to 12 windings of the bundle of filaments (5), preferably carbon fibers, are wound successively, including preferably four braids in polar pattern, preferably three braids in cross-weave pattern, preferably three braids in hoop pattern and, preferably, another one braid in polar pattern, and preferably at least one optical fiber (6) is wound together with the bundle of fibers (5), preferably carbon fibers, in the last polar braid.
